(19) United States
(12) Patent Application Publication
(10) Pub. No.: US 2012/0246068 A1
(43) Pub. Date: Sep. 27, 2012

(54) Lottery Gift Card/ Lottery Credit Card/ Lottery Card

(76) Inventors: Caroline Lauren Lauren-Frost, Cypress, TX (US); Abigail Rene Billey/Frost, Cypress, TX (US)

(21) Appl. No.: 13/221,878

(22) Filed: Aug. 30, 2011

Related U.S. Application Data
(60) Provisional application No. 61/449,387, filed on Mar. 4, 2011.

(51) Int. Cl. G06Q 20/34

(52) U.S. Cl. 705/41

(57) ABSTRACT

It is a new way of paying for your lottery. It makes it easier, because you do not have to carry cash. This is will revolutionize the way you pay to play the lottery.

### SUMMARY OF INVENTION

The Lottery card is a card that you can pay for, load, or buy preloaded and pay for you lottery games, tickets, etc with. The advantages to having one of these is so that the next time you want to play the lottery you will not have to worry about having cash, or going through the ATM to get cash. It will come in many patterns and shapes, but the way it is used will be the same, to pay for playing the lottery. This will revolutionize the way you play the lottery.

### DESCRIPTION OF DRAWINGS

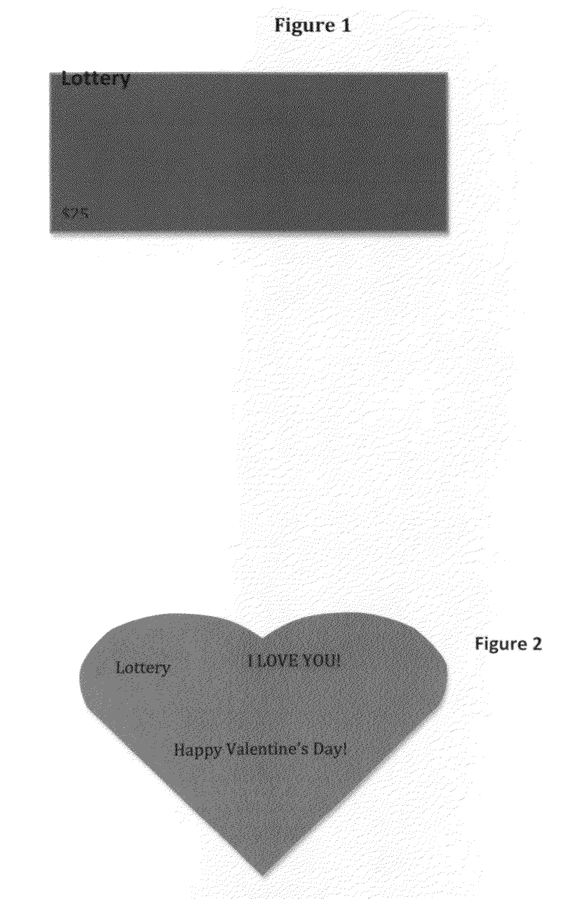

These are simple, but when they can be designed in many, many different ways. In FIG. 1 you will see a plain, generic view of the card. There are infinitely many ways you can pattern and customize the card. In FIG. 2 you will see a way that you could customize the card for a holiday, in this example the holiday will be Valentine's Day.

### DESCRIPTION OF INVENTION

The card changes the way you pay for the lottery. You would make it like any other credit card, gift card, or ATM card. They would make it like you would a gift card, just with special codes so that the lottery machine knows that you are using a lottery gift card. You can also make the shapes, colors, and patterns different. This is different than what is out there, you cannot pay for the lottery by using a regular gift card, and you cannot even use a debit card. It could not be in any form copied by a credit card company, because you can't pay for the lottery with a credit card, you do not own the money to a credit card. Gift cards are preloaded cash. You can add different designs to the card, maybe different features, colors, designs, shapes, software, etc. It hits a broad array of designs and software. This is not just any gift card. It is a Lottery Card. People hardly carry cash with them, except to play the lottery. This card will be a way to make playing the lottery easier.

It solves a way to pay for the Lottery; people usually have to go get cash to pay for the lottery. You have to carry cash or a debit card (which not many accept, including the lottery machines) to play the Lottery, but if you have a gift card, you can preload it and pay for the Lottery that way. It is a preloaded card for the lottery. When you play the lottery you have to play in cash, but if you have a preloaded card, you do not have to carry cash or go to the ATM. It is a gift card, but it is a gift card for the lottery.

The current system has where you only can play in cash, but if you can play with a card, you do not have to carry all the cash. The gift card makes playing the lottery easier.

It is basically a gift card, but specific for the lottery. You can design it, which way you like. It just is special to the lottery. It is plastic and has a certain data code that will allow you to pay for the way you play for your lottery. It can have many designs, shapes, and codes. It is a gift card or an ATM card, but for the lottery. It is the plastic way to pay for the lottery you play.

It is all connected the way a credit card or gift card is connected. It will have a special number for the lottery machine to pay. The invention provides a better way to pay for playing the lottery. It is a gift card that is the lottery's own gift card.

The card is necessary, but the designs for it are optional. For Florida, do a Florida design. For Texas do a Texan design, Etc.

The way the user would use it is go and buy a card, it can be a preloaded card with X amount, or one where you choose the amount, you can also refill the card as you go along. The use would go and play the lottery, get out their card, and play however much they want, but once it runs out, they will not be able to but more lottery until they either buy a new preloaded card, or refill the one they already have. You can refill it at the lottery machine, or buy a new one at participating retailers. Or another way to put it: You pay for the card, and then you go to a place where you can play the lottery. Then they say I want x amount of lottery and then they would pay for it. If their card ran out, they could also load it again. Or they can go use the machine and play, then also if they need to load their card again.

It can be the way of the future for lottery playing. It can be a new way of embedding codes for the lottery paying and playing.

The improvement is a way to save time not having to drive to the ATM to get cash to play the lottery; you will also save gas. It is more convenient to have a card with you than to have to pull out cash. This will make paying to play the lottery easier.

1. This will make playing the lottery so much easier for the user. This is because the user will not have to worry about going to the ATM or having cash with them to play the lottery. It will also save gas, because it takes most at least a mile or more to go to an ATM, that extra mile, when you add it up, going to just find an ATM means that that is more pollution that you are putting into the air.

2. I also believe that the states with the Lottery will have bigger revenues, because if you give the card or buy it for yourself, the state will get money from it.
